(19) United States
(12) Patent Application Publication
(10) Pub. No.: US 2025/0188785 A1
(43) Pub. Date: Jun. 12, 2025

(54) SAFETY INSTALLATION HAVING AN ACCELERATION SENSOR FOR INDUSTRIAL DOORS

(71) Applicant: CEDES AG, Landquart (CH)

(72) Inventor: Bernd KAGERER, Duesseldorf (DE)

(73) Assignee: CEDES AG, Landquart (CH)

(21) Appl. No.: 18/967,873

(22) Filed: Dec. 4, 2024

(30) Foreign Application Priority Data
Dec. 11, 2023 (EP) 23 215 580.4

(51) Int. Cl. E05F 15/43; E05F 15/41; E05F 15/665

(52) U.S. Cl. CPC E05F 15/43; E05F 15/41; E05F 15/665; E05F 2015/437; E05Y 2201/684; E05Y 2400/3017; E05Y 2400/502; E05Y 2400/54; E05Y 2900/132

(57) ABSTRACT

Proposed is a safety installation for industrial doors that are mounted movably between two guide rails, having at least one optical sensor system for recognizing objects, wherein the optical sensor system is mounted in at least one housing able to be fastened in each case to the guide rails. In order to be able to impose lower mounting requirements while keeping at least the same level of safety, the housing and/or at least one of the housings has an acceleration sensor for measuring a vibration and for supplying vibration data from which an evaluation unit evaluates whether the door has left the guide.

This application claims the benefit under 35 USC § 119 (a)-(d) of European Application No. 23 215 580.4 filed Dec. 11, 2023, the entirety of which is incorporated herein by reference.

### FIELD OF THE INVENTION

The present invention relates to a safety installation for industrial doors and an industrial door system.

### BACKGROUND OF THE INVENTION

It is known from the prior art to provide industrial doors with various types of switches in order to be able to interrupt the movement of the door when the door leaves the guide rail, that is to say in the event of a fault. In the case of high-speed doors, for example, radio crash switches are conventionally used, while slack-wire switches are used in the case of sectional doors. In the case of roller doors, this protection again is even uncommon for technical reasons.

### SUMMARY OF THE INVENTION

One object of the present invention is to provide a safety installation for industrial doors that imposes lower mounting requirements while maintaining at least the same level of safety.

The safety installation according to the present invention is intended in principle for industrial doors, that is to say, for example, for industrial door systems that use a roller door or film door, a sectional door or a high-speed door to close or cover a door opening. As has been found, the present invention may advantageously also be used, in particular, in the case of roller doors and film doors, in which use has hitherto been problematic for technical reasons. One reason for this is that conventional sensors from the prior art have been installed on the movable part of the industrial door that travels along with it, which is technically difficult in the case of lightweight roller doors or film doors, which are also wound onto a roller to save space. As described below, according to the present invention, this advantage is achieved in that the stationary part of the optical sensor system, which is typically installed parallel to or on a guide rail, additionally has an acceleration sensor that may be used to detect vibrations.

The industrial doors are mounted between two guide rails and are guided when moving. The guide rails may have, for example, a U-shaped profile. The edges on both sides of the door are guided in the U-shaped receptacles. The two guide rails may be aligned with one another by way of the open side of the U-shaped profile, so that the door edges are guided and are able to run in the U-shaped profile on both sides.

Depending on the embodiment, the optical sensor system is, for example, a light barrier or a light grid. Both one-way and two-way light barriers or detectors may be considered. In the case of one-way detectors, the transmitter and receiver are located opposite one another, the transmitter in the sensor bar on one side of the door and the receiver in the sensor bar on the other side of the door. In the case of a two-way light barrier, the transmitter and receiver are accommodated in the same sensor bar. The opposite sensor bar then contains a reflector that reflects the beam coming from the transmitter back to the receiver. It is also conceivable to use a sensor bar having a distance sensor, for example, a TOF sensor (time-of-flight sensor). In contrast to a pure interruption sensor (for example, a simple light barrier), this sensor is able to supply not only the information that an object is present at all, but also the distance at which this object is located.

If the door leaves the guide rail, this gives rise to vibrations that, as a rule, occur to a greater extent than vibrations that occur during normal operation when the door moves in the guide. These vibrations are able to be detected. Until now, there has been the prevailing technical preconception that this problem is able to be detected particularly well if the sensor is seated directly on the moving door and travels along with it. On the one hand, mounting on the door may be problematic in the case of different door types, for example, in the case of roller doors or film doors, which are flexible and are rolled up. In addition, the types of data transmission from the sensor are restricted; for example, wireless transmission usually has to take place.

The optical sensor system is accommodated in a housing. An individual light barrier may involve an individual housing only for the transmitter and a separate one only for the receiver. In the case of a light grid, transmitters or receivers may also be accommodated in a sensor bar. This housing is able to be attached directly to the guide rail, such that the vibrations are able to be transmitted mechanically from the guide rail to the housing. The individual housings or the sensor bar may be arranged parallel to the corresponding guide rail. According to the present invention, however, an acceleration sensor is now additionally arranged in the housing and is thus able to measure the vibrations. Mounting on the movable door may thereby advantageously be dispensed with, and the sensor no longer has to travel along with the door. It is thus possible to use the safety installation according to the present invention while maintaining the high level of safety, including for basically all types of door systems. The sensor installation is thus able to be used in a particularly flexible manner.

The acceleration sensor may be accommodated in a space-saving manner in the housing, that is to say both in a sensor bar and in an individual housing. In addition, the acceleration sensor is advantageously also installed in the housing or in the sensor bar at the location where the electronics, in particular, the connection to the evaluation unit, are also located.

Provision is furthermore made for an evaluation unit that evaluates the vibration data or at least carries out an assignment and assigns the metadata the information as to whether or not the industrial door has left the guide rail. By way of example, the evaluation unit may assume that a certain basic vibration occurs when the door is moving. However, when the guide rail is left, a stronger vibration may be recorded, with the result that the sensor detects this vibration from a certain threshold value, for example, the amplitude of the vibrations, and interprets it as a fault.

The same evaluation unit or another evaluation unit may furthermore carry out the evaluation as to whether or not an object is located in the region of the door movement and therefore whether or not a hazardous situation exists. This evaluation unit may also be connected to the door controller and stop the door drive or release the movement.

In one development of the present invention, the evaluation unit may have a connection to a server or a cloud. Depending on the complexity of the evaluation and analysis, for example, using pattern recognition or analysis using calculation and recognition of the envelope of the vibration data, it may be advantageous to use a powerful computer unit, especially since the recognition and assignment should also take place in real time. This is because the door movement should be switched off immediately and not with a large time delay. However, since such a computing unit is very expensive and also cannot be installed in a door system, it is possible to use a powerful computing unit able to be accessed via the Internet. The evaluation unit may thus advantageously also implement an IOT-based (Internet of Things) evaluation.

In general, the evaluation unit may then forward the result of the evaluation, that is to say, in particular, in the simplest case a digital signal, as to whether or not a fault is present, to the door controller, so that the door controller continues or stops the door movement.

Accordingly, an industrial door system according to the present invention, therefore, comprises an industrial door for closing or covering a door opening, the industrial door being mounted movably or displaceably in two guide rails on either side of the door. Provision is furthermore made for a door drive for moving the door. In order to detect that the door has left the guide, in particular, independently of the type of the door system, provision is advantageously made for a safety installation according to the present invention or a safety installation according to one exemplary embodiment of the present invention.

With regard to the door opening, the guide rails may, for example, be installed on the frame members of the door opening laterally, that is to say, each on either side of the door. The industrial door itself is generally attached at the top in the region of the lintel of the door opening.

In one advantageous exemplary embodiment, the industrial door system also comprises a corresponding door controller with which the safety installation interacts, that is to say that receives, from the evaluation unit, the information as to whether a fault is present and the door movement should be stopped immediately.

In principle, depending on the design variant, the evaluation unit and, for example, the door controller may also form one structural unit or constitute separate structural units.

In one particularly advantageous development of the present invention, the door itself may be designed without sensors, that is to say, the sensor does not have to travel along with the door, but rather is accommodated in a static part, for example, the sensor bar or the housing. Data may thus also be transmitted from the sensor more flexibly, be this in wired or wireless fashion.

### BRIEF DESCRIPTION OF THE DRAWING

One exemplary embodiment of the present invention is illustrated in the drawing and is explained in more detail below, with further details and advantages being specified.

FIG. 1 shows an industrial door system having a safety installation according to the present invention.

### DETAILED DESCRIPTION OF THE INVENTION

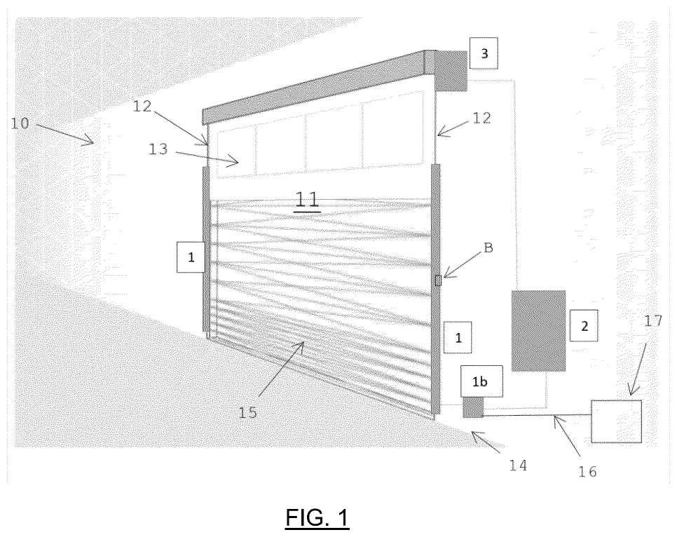

FIG. 1 shows an industrial door system 10 having a door opening 11. A respective guide rail 12, in which the door 13 is able to run, is arranged on either side in the region of the frame members of the door opening. In the open state, the door 13 is mounted in the region of the lintel, where the door drive 3 is also seated.

The sensor bars 1 are arranged parallel to the guide or guide rails 12 as part of the safety installation 14 in which the light grid 15 is accommodated. In addition, the sensor bars 1 have an acceleration sensor B that is accommodated or mounted in or else on the housing 1. The light grid 15 and the acceleration sensor B are connected to an evaluation unit 1b. This in turn has an IoT connection 16 to an external server 17 in order to analyze the vibration data from pattern recognition or with inclusion of the evaluation of the envelope and to decide whether or not a fault is present. The result signal is then transmitted to the door controller 2, with the result that the drive is either released or stopped. The door controller 2 in turn is connected to the door drive 3 and forwards this release or this interruption command to the door drive 3. If possible, a command to rethread the door may also be transmitted.

### REFERENCE SIGNS

1 Sensor bar
1b Evaluation unit
2 Door controller
3 Door drive
10 Industrial door system
11 Door opening
12 Guide rail
13 Door
14 Safety installation
15 Light grid
16 IoT connection
17 External server
B Acceleration sensor

1-13. (canceled)

14. A safety installation for industrial doors that are mounted movably between two guide rails, comprising:
at least one optical sensor system for recognizing objects,
wherein the optical sensor system is mounted in at least one housing able to be fastened in each case to the guide rails,
wherein the housing and/or at least one of the housings has an acceleration sensor for measuring a vibration and for supplying vibration data, and
wherein provision is made for an evaluation unit that evaluates, from the vibration data and/or assigns, to the vibration data, whether the industrial door has left one of the guide rails in order to forward this information to a door controller for controlling the door drive and/or a signal and thus to stop or start the industrial door or allow it to continue.

15. The safety installation according to claim 14, wherein the optical sensor system is designed as:
a light barrier and/or
a light grid and/or
a distance sensor, in particular as a TOF sensor.

16. The safety installation according to claim 14, wherein the housing and/or at least one of the housings is designed in each case as a sensor bar.

17. The safety installation according to claim 16, wherein exactly two sensor bars are provided, wherein in particular:
a first of the sensor bars comprises transmitters of the light barrier and/or of the light grid and the second of the sensor bars comprises receivers, or
a first of the sensor bars has transmitters and receivers and the second sensor bar has reflectors for reflecting the light emitted by the transmitters in the direction of the receivers, or
at least one of the sensor bars or the sensor bar comprises TOF sensors.

18. The safety installation according to claim 14, wherein the evaluation unit has a connection to a server and/or to a cloud for analyzing the vibration data, wherein in particular the server and/or the cloud are part of the evaluation unit.

19. The safety installation according to claim 14, wherein the evaluation unit, in particular the server and/or the cloud, are designed to subject the vibration data to pattern recognition or to recognition of an envelope of the vibration data for evaluation purposes.

20. An industrial door system, comprising:
an industrial door for closing or covering a door opening,
two guide rails for movably mounting the industrial door,
a door drive for the motorized movement, in particular rolling up and rolling down, of the industrial door within the guide rails,
a safety installation according to claim 14.

21. The industrial door system according to claim 20, wherein the safety installation and/or the housing and/or the housings are each mounted in parallel on one of the guide rails.

22. The industrial door system according to claim 20, wherein the guide rails are designed as a U-shaped profile guide.

23. The industrial door system according to claim 20, wherein the industrial door is designed as a roller door, film door, sectional door or high-speed door.

24. The industrial door system according to claim 20, wherein a door opening is present, wherein in particular the guide rails are each installed opposite one another on a frame member of the door opening and/or the industrial door is attached to the lintel of the door opening.

25. The industrial door system according to claim 20, wherein provision is made for a door controller for controlling the door drive, said door controller being connected to the evaluation unit.

26. The industrial door system according to claim 20, wherein the industrial door is designed without sensors.
